(19) United States
(12) Patent Application Publication
(10) Pub. No.: US 2013/0051909 A1
(43) Pub. Date: Feb. 28, 2013

(54) METAL MEMBER AND RESIN PRODUCT HAVING METAL MEMBER

(71) Applicant: Takakazu TAKAHASHI, Makinohara-shi (JP)

(72) Inventor: Takakazu TAKAHASHI, Makinohara-shi (JP)

(73) Assignee: YAZAKI CORPORATION, Tokyo (JP)

(21) Appl. No.: 13/590,545

(22) Filed: Aug. 21, 2012

(30) Foreign Application Priority Data
Aug. 22, 2011 (JP) 2011-180434

(51) Int. Cl. F16B 17/00

(52) U.S. Cl. 403/345

(57) ABSTRACT

A metal member which is fixed to a through hole provided in a resin product, includes: a side surface which faces an inner surface of the through hole when the metal member is fixed to the though hole, the side surface comprising: a first part which is provided in the vicinity of an end part of the side surface; and a second part which has an outside diameter larger than that of the first part and which has concave and convex thereon.

### BACKGROUND OF THE INVENTION

The present invention relates to a metal member fixed to a member to be inserted made of a resin and a resin product having a metal member provided with the above-described metal member.

There is a structure that a metal member (a collar) is fixed to a resin product having a through hole. FIGS. 5A to 6C show an example of a structure in which a collar 1 is fixed to a through hole 3 of a resin product 2 by a press-in operation. Mainly shown in FIGS. 6A to 6C, when the collar 1 is pressed-in to the through hole 3 of the resin product 2, an inner wall of the though hole 3 is scraped out to generate burrs 4 (scraped residue). Since the burrs 4 form foreign materials which cause short-circuit between circuits, when the burrs are generated, the burrs 4 need to be removed in a product manufacturing process, so that a production cost is increased. As a related-art technique for meeting such a situation, for instance, as shown in FIGS. 7A to 7C, a structure is formed in which an inner wall of a through hole 3 is divided into an upper press-in area and a non press-in area and a collar 1 has a form corresponding to the structure to retain burrs generated in the press-in area in an inner part (for instance, see JP-A-2010-139018).

Further, as a collar used for an insert molding, there are related-art structures shown in FIGS. 8A and 8B. In FIG. 8A, many recessed forms are provided in a side surface of a cylindrical collar. In FIG. 8B, an outside diameter of a cylindrical side surface is smaller in a central part than that in upper and lower end parts. In such structures, a state that the collar is fixed to a resin product is properly maintained. Further, for a collar into which a bolt is inserted, a related-art technique is proposed that a groove inclined in a direction reverse to a thread is formed on a side surface of the collar in order to prevent a screw member from being unfastened (for instance, see Japanese Utility Model No. 3103899).

Ordinarily, when a metal member harder than a resin product is fixed to the resin product having a through hole by a press-in or an inserting operation, the metal members of different forms are used properly depending on fixing methods. As a result, similar members are increased, so that a countermeasure is required from viewpoints of reduction of a cost or reduction of the number of managing processes.

### SUMMARY

This invention provides a technique for solving the above-described problems

An aspect of the invention provides a metal member which is fixed to a through hole provided in a resin product, the metal member comprising: a side surface which faces an inner surface of the through hole when the metal member is fixed to the though hole, the side surface comprising: a first part which is provided in the vicinity of an end part of the side surface; and a second part which has an outside diameter larger than that of the first part and which has concave and convex thereon.

The side surface may comprise the first part in two areas in the vicinity of both end parts.

An aspect of the invention provides a resin product including a through hole, the resin product comprising: a metal member fixed to the through hole, and the metal member comprising: a side surface which faces an inner surface of the through hole when the metal member is fixed to the though hole, the side surface comprising: two first parts each of which has an outside diameter of the same size as that of the through hole in section, and which are provided in the vicinity of both end parts of the side surface; and a second part which has an outside diameter larger than those of the first parts and which has concave and convex thereon.

### BRIEF DESCRIPTION OF THE DRAWINGS

FIG. 1 is a perspective view of a collar according to an exemplary embodiment.

FIG. 2 is a perspective view of a resin product according to an exemplary embodiment to which the collar is fixed.

FIG. 3 is a perspective view of the resin product according to the exemplary embodiment showing a state that the collar is fixed to the resin product.

FIG. 4 is a sectional view of the resin product according to the exemplary embodiment showing a state that the collar is fixed to the resin product.

FIGS. 5A, 5B and 5C are perspective views of a press-in collar and a resin product according to a related-art technique.

FIGS. 6A, 6B and 6C are sectional views of the press-in collar and the resin product according to the related-art technique.

FIGS. 7A, 7B and 7C are perspective views of a press-in collar and a resin product according to a relate-art technique.

FIGS. 8A and 8B are perspective views of insert molded collars according to related-art techniques.

### DETAILED DESCRIPTION OF EMBODIMENTS

Now, a mode for carrying out the present invention (refer it to as an “exemplary embodiment”, hereinafter) will be described below by referring to the drawings. In the present exemplary embodiment, as a metal member fixed to a resin product, a cylindrical collar is exemplified. As a metal member other than the above-described collar, a square pole shaped or hexagonal pole shaped nut is exemplified.

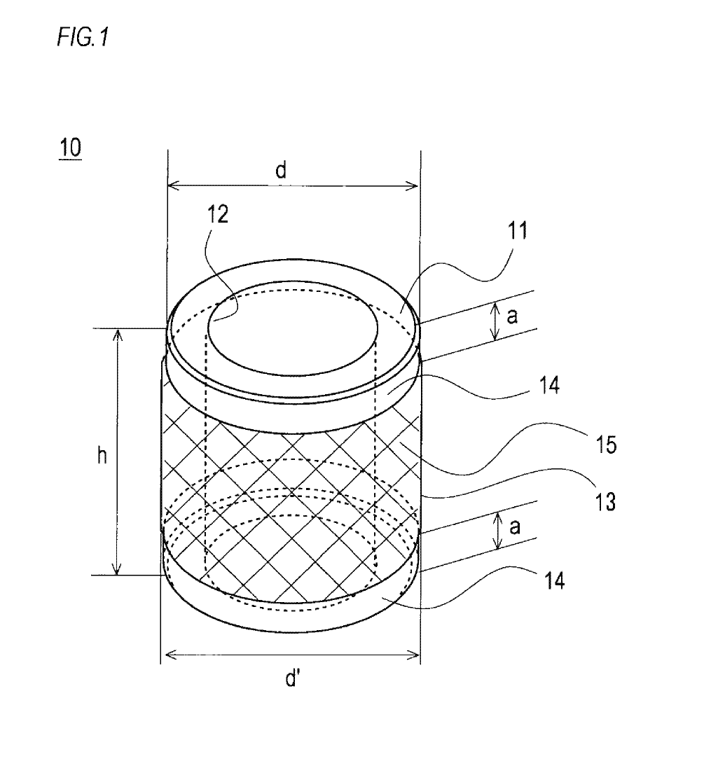

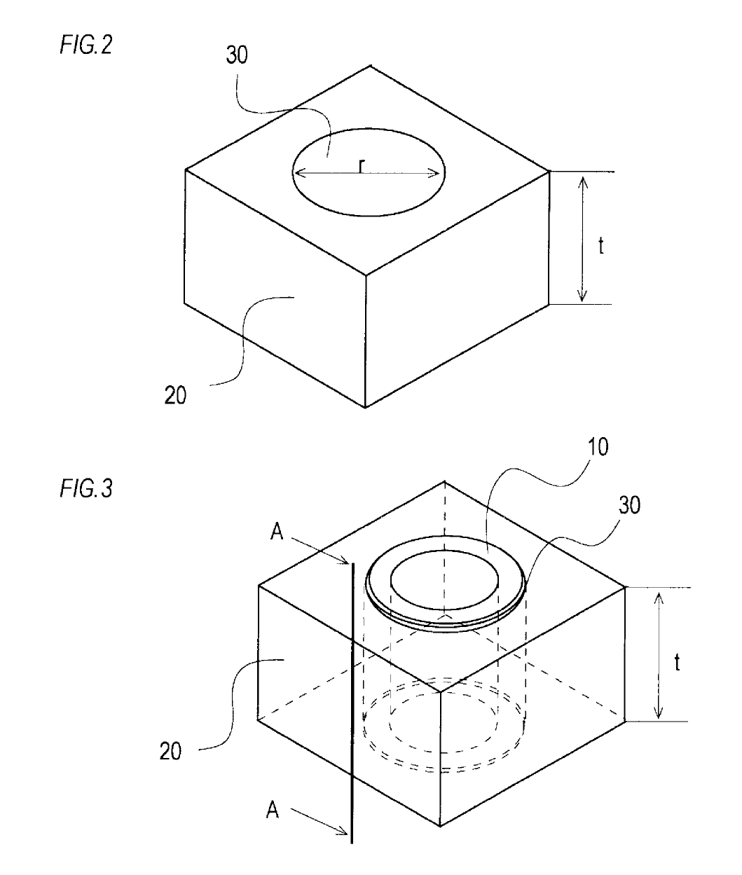

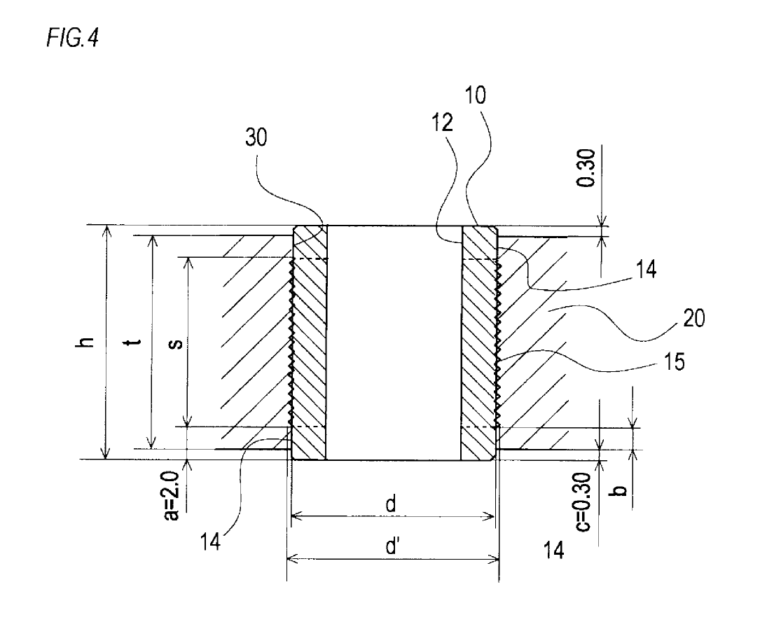

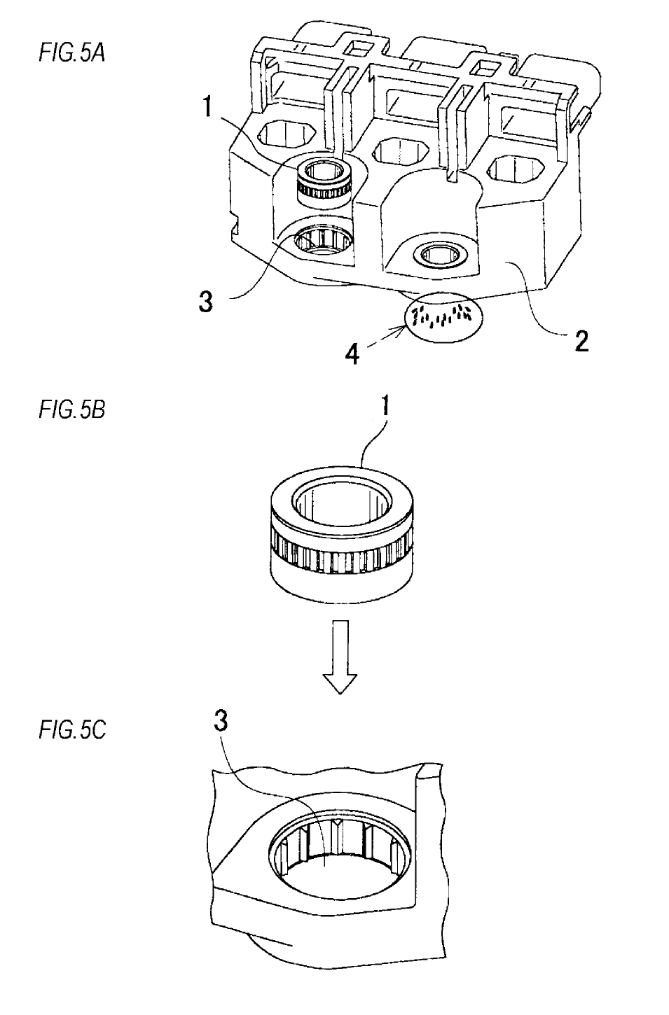

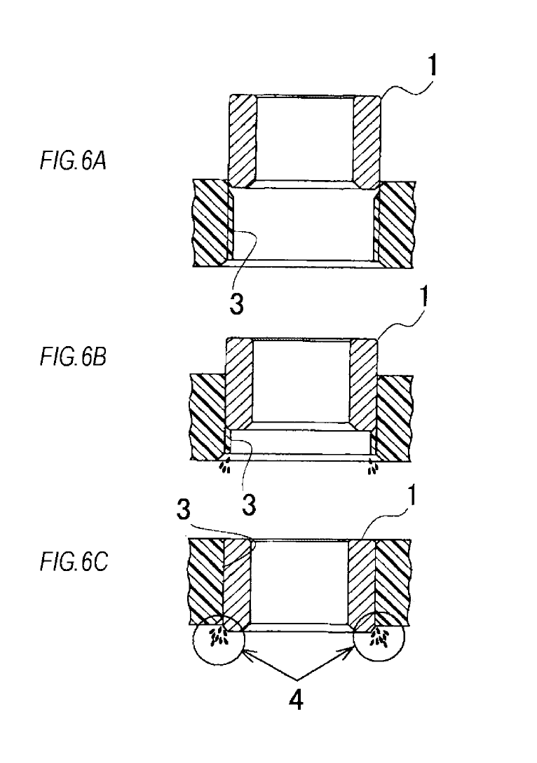

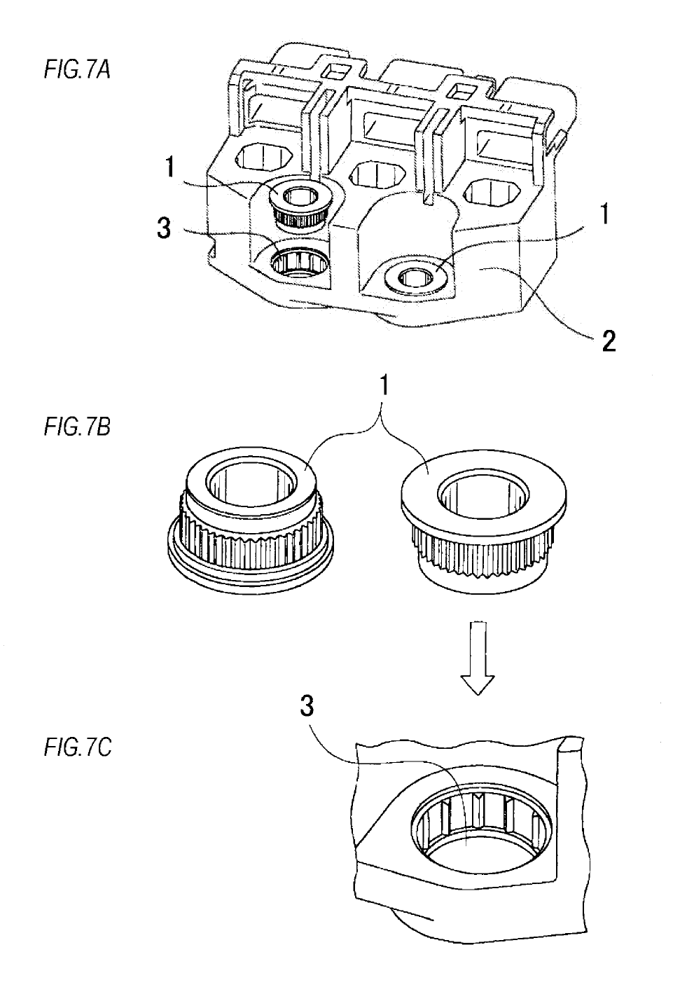

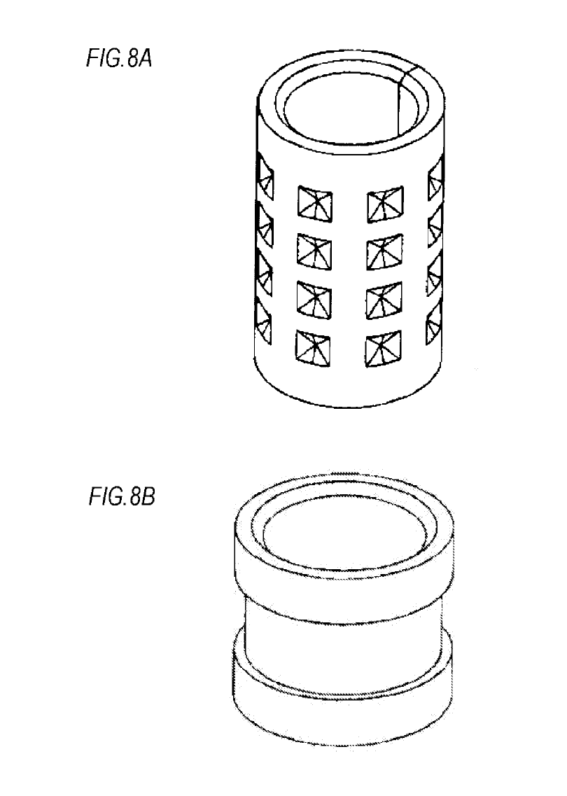

FIG. 1 is a perspective view of a collar 10 according to an exemplary embodiment. FIG. 2 is a perspective view of a resin product 20 to which the collar 10 is fixed. FIG. 3 is a perspective view of the resin product 20 showing a state that the collar 10 is fixed thereto. FIG. 4 is a sectional view (a section taken along a line A-A in FIG. 3) of the resin product 20 showing a state that the collar 10 is fixed to the resin product.

For instance, as shown in FIG. 1, the collar 10 is a member made of metal and has a cylindrical form. As shown in FIG. 2, a through hole 30 is provided in the resin product 20. As shown in FIG. 3, the collar 10 is fixed to the through hole 30 of the resin product 20 by an inserting molding method or a press-in method. Namely, the collar 10 is formed so as to be used for both the insert molding method and the press-in method without discrimination.

In the collar 10, an insert hole 12 is provided which vertically passes through in an axial direction of the cylinder (in a vertical direction in FIG. 1) and has annular circular surfaces 11 formed in an upper surface and a bottom surface. A bolt is inserted the insert hole 12.

In the collar 10, a roughing work is applied to a prescribed area of a side surface 13 of the collar 10 to form concave and convex on the area so that the collar 10 does not slip out of the resin product 20 when the collar 10 is fixed to the through hole 30. Here, when the collar 10 is inserted in and fixed to the through hole 30, the side surface 13 faces an inner surface of the through hole 30. Specifically, the collar 10 includes side surface end parts 14 formed in areas in the vicinity of upper and lower end parts in the side surface 13 and a knurling work part 15 formed in an area between the two side surface end parts 14.

The side surface end parts 14 are non press-in areas and an outside diameter d (refer it to as a “first outside diameter d”, hereinafter) thereof is set to be equal to an inside diameter r of the through hole 30. Surfaces of the side surface end parts 14 are formed by smooth surfaces without forming concave and convex so as not to generate a large resistance during a press-in operation.

To the knurling work part 15 as a press-in area, a knurling work of an indented form in section is applied as a whirl stop (for prevention of slipping out). A height s of the knurling work part 15 is set to s=h−2a relative to a height h of the collar 10 (an axial length) and a height a of the side surface end part 14. Here, the height a of the side surface end part 14 is constantly set to 2.0 mm. Further, an outside diameter d′ (refer it to as a “second outside diameter d′”, hereinafter) of the knurling work part 15 is set to be slightly larger than the first outside diameter d (d<d′). A form as the knurling work and the second outside diameter d′ are suitably determined depending on a fixing force required during a fixing operation, a hardness of the resin product 20 and a force exerted during the press-in operation.

A depth t of the through hole 30 formed in the resin product 20 is set to be slightly smaller than the height h of the collar 10 (the axial length). Here, the depth t is set to t=h−0.6 mm. More specifically, under a state that the collar 10 is fixed to the through hole 30, amounts of protrusion c of the upper and lower annular circular surfaces 11 are respectively set to 0.3 mm. Namely, the depth t of the through hole 30, the height h of the collar 10 and the amount of protrusion c have a relation expressed by t=h−2c.

According to such a structure, below-described effects can be achieved. When the collar 10 as the metal member is pressed-in to the resin product 20, since the knurling work part 15 bites an inner wall surface of the through hole 30 as the collar is more pressed-in, the collar 10 can be properly fixed. Further, burrs (resin residue) generated in the course of the press-in operation can be constantly retained in an area b shown in FIG. 4. Accordingly, the generated burrs can be prevented from being rejected outside as foreign materials.

Further, when the collar 10 is insert molded, since a resin flows into a periphery of the knurling work part 15 to fix the collar 10, the burrs are not generated. Further, in accordance with an anchor effect of the knurling work part 15, a fixing state of the collar 10 to the resin product 20 is properly ensured.

The present invention is described above in accordance with the exemplary embodiment. It is to be understood to a person with ordinary skill in the art that the exemplary embodiment is merely exemplified and various modified examples may be made by component elements thereof and combinations of them and the modified examples may be included within a range of the present invention.

For instance, in the above-described exemplary embodiment, the knurling work part 15 is formed so as to be sandwiched between the side surface end parts 14 at both the ends. Namely, the collar is vertically symmetrically formed and can be used without discrimination in a press-in direction. However, the collar may be used by discriminating the press-in direction. For instance, when the area b of a lower side can be ensured ahead of the press-in direction during the press-in operation, the burrs are not discharged outside. Accordingly, the knurling work part 15 may be formed to a part of the side surface end part 14 in a rear side of the press-in operation (an upper side shown in the drawing). Namely, the side surface end part 14 may be formed only in one side.

Further, an area sandwiched between the side surface end parts 14 is not limited to a knurling worked part (the knurling work part 15), a form may be used which bites an inner wall surface when the collar is pressed-in to the through hole 30 and fixed thereto and, a form may be used in which a resin flows into a concave and convex form to exhibit an anchor effect when the collar is insert molded and fixed the through hole.

According to an aspect of the invention, the metal member is provided which can be used and fixed in any of processes for pressing-in or insert molding the metal member to the resin product, and a technique can be provided by which burrs can be avoided from being generated when the metal member is fixed to the resin product by the press-in operation.

What is claimed is:

1. A metal member which is fixed to a through hole provided in a resin product, the metal member comprising:
a side surface which faces an inner surface of the through hole when the metal member is fixed to the though hole, the side surface comprising:
a first part which is provided in the vicinity of an end part of the side surface; and
a second part which has an outside diameter larger than that of the first part and which has concave and convex thereon.

2. The metal member according to claim 1, wherein the side surface comprises the first part in two areas in the vicinity of both end parts.

3. A resin product including a through hole, the resin product comprising:
a metal member fixed to the through hole, and the metal member comprising:
a side surface which faces an inner surface of the through hole when the metal member is fixed to the though hole, the side surface comprising:
two first parts each of which has an outside diameter of the same size as that of the through hole in section, and which are provided in the vicinity of both end parts of the side surface; and
a second part which has an outside diameter larger than those of the first parts and which has concave and convex thereon.
